(19) United States
(12) Patent Application Publication
(10) Pub. No.: US 2022/0261881 A1
(43) Pub. Date: Aug. 18, 2022

(54) SYSTEM AND METHOD FOR E-COMMERCE TRANSACTIONS USING AUGMENTED REALITY

(71) Applicant: BROADSTONE TECHNOLOGIES, LLC, Frederick, MD (US)

(72) Inventors: Taimur Aslam, Frederick, MD (US); Andrew J. Surwilo, Allendale, NJ (US)

(21) Appl. No.: 17/650,948

(22) Filed: Feb. 14, 2022

Related U.S. Application Data
(60) Provisional application No. 63/200,106, filed on Feb. 14, 2021.

(51) Int. Cl. G06Q 30/06; G06Q 30/02; G06F 3/01; G06Q 20/36; G06V 20/20; G06T 19/20; G06T 19/00

(52) U.S. Cl. CPC G06Q 30/0643; G06Q 30/0232; G06F 3/011; G06T 19/006; G06V 20/20; G06T 19/20; G06Q 20/36

(57) ABSTRACT

According to some embodiments, a method is performed by an augmented reality (AR) device. The AR device comprises a display configured to overlay virtual objects onto a field of view of a user in real-time. The method comprises receiving an indication from an e-commerce engine that an AR model is available to the user, wherein the AR model represents an e-commerce product and comprises attributes describing the e-commerce product, and retrieving the AR model from the e-commerce engine. The AR model represents a product offered by the e-commerce engine (e.g., gift card, coupon code, offer code). The method further comprises determining a surface in the field of view of the second user for projection of the AR model and displaying on the determined surface an AR projection based on the AR model to the user via the display. The AR projection represents the product represented by the AR model.

### RELATED APPLICATION

This application claims the benefit of U.S. Provisional Patent Application No. 63/200,106 filed on Feb. 14, 2021, the disclosure of which is incorporated herein by reference in its entirety.

### BACKGROUND

The present disclosure relates generally to augmented reality (AR) and more particularly to a system and method for e-commerce transactions using AR.

### SUMMARY

According to some embodiments, a system for performing an electronic transaction in an augmented reality (AR) environment comprises an e-commerce engine and an AR device. The e-commerce engine comprises one or more processors operable to: receive a request to transmit an AR model to a user, wherein the AR model represents an e-commerce product and comprises attributes describing the e-commerce product; determine an AR device associated with the user; and transmit an indication to the AR device that the AR model is available to the user. The AR device comprises a display configured to overlay virtual objects onto a field of view of the user in real-time and one or more processors coupled to the display. Thea one or more processors are operable to: receive the indication that the AR model is available to the user; retrieve the AR model from the e-commerce engine; determine a surface in the field of view of the second user for projection of the AR model; and display on the determined surface an AR projection based on the AR model to the user via the display.

In particular embodiments, the AR device is further operable to receive input from the user to manipulate the AR model and manipulate the AR model according to the received input.

In particular embodiments, the AR model comprises a representation of a gift card, The AR device may be further operable to store the representation of the gift card in a digital wallet.

In particular embodiments, the AR model comprises a container and the AR device manipulates the AR model by opening the container.

In particular embodiments, the e-commerce engine is further operable to receive an indication of the input received from the user to manipulate the AR model and store the indication of the input received from the user to manipulate the AR model. The e-commerce engine may be further operable to analyze patterns within the stored indication of the input received from the user to manipulate the AR model.

In particular embodiments, the e-commerce engine is further operable to generate a report pertaining to the AR model retrieved by the AR device.

### BRIEF DESCRIPTION OF THE DRAWINGS

FIG. 1 illustrates a block diagram of a system for e-commerce transactions using augmented reality (AR), in accordance with a particular embodiments.

FIGS. 2A and 2B illustrate a augmented reality view of an augmented reality model, according to particular embodiments.

FIG. 3 illustrates a flowchart of a method performed by an AR device, in accordance with particular embodiments.

FIG. 4 is a block diagram illustrating an example AR device.

FIG. 5 illustrates an example of an apparatus to implement one or more example embodiments described herein.

### DETAILED DESCRIPTION OF DISCLOSED EMBODIMENTS

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Moreover, any functionality described herein may be accomplished using hardware only, software only, or a combination of hardware and software in any module, component or system described herein. Furthermore, aspects of the present disclosure may take the form of a computer program product embodied in one or more computer readable media having, computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RE, etc., or any suitable combination of the foregoing.

Computer program code for carrying out operations for aspects of the present disclosure may be written in any combination of one or more programming languages, including a symbolic programming language such as Assembler, an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perk COBOL 2002, PUP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, with execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data pressing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Particular embodiments described herein enable merchants to launch digital campaigns using augmented reality (AR) to attract users, build a loyal group of repeat customers, launch promotional marketing campaigns, collect real-time feedback on the effectiveness of the promotional campaigns, and any other suitable interactions with a customer and/or user.

Particular embodiments enable merchants to collect real-time feedback on the efficacy of their promotional campaigns and facilitate tailoring of the offering based on the response received. The real-time interactions are not possible through conventional paper coupons or other static digital marketing coupons.

Coupons and offer codes are used by merchants to entice users to transact on their e-commerce sites and/or physical locations. Particular embodiments provide an enhanced system for merchants to offer coupons using an interactive medium (e.g., AR) that engages users.

Particular embodiments may be used by e-commerce vendors as well as brick and mortar merchants to launch, monitor, and enhance their marketing campaigns. Particular embodiments may be used by merchants to promote their products and enhance their e-commerce sales. Particular embodiments improve the transaction volume on a merchant's e-commerce site by enabling a playful interaction between users and merchant sites.

In general, some embodiments comprise: a data repository of augmented reality models; a data server to process business logic; a software application executable on smart phones, tablets, AR devices, and/or computers; and/or a website and server to process annotation of augmented reality models'

Particular embodiments enable a user to download and install the software application on a device of their choice. The user, upon completion of a signup process, authenticates their identity to the business logic server by providing user credentials.

Upon successful login, the user is able to, for example: browse the available augmented reality models; project the augmented reality models in the user's surroundings or any other selected surrounding; interact with the models by rotating them along a 3-dimensional axis; provide feedback by completing a survey; and/or conduct an audio/video teleconference. A registered merchant may upload an augmented reality model, build a longitudinal global positioning coordinate, associate a feedback survey with the model, and/or embed a special offer that is revealed after the user completes a survey or answers a question.

Some embodiments project an augmented reality model when the user is in close proximity of a location (e.g., geo-spatial triggering). By using the location coordinates obtained from the user, the system is able to project an augmented reality model to the user. The user may interact with the model and follow a series of steps as indicated by the embedded model. Upon completion of the required tasks, the user may be presented with a unique offer code for redemption at the merchant's location. The code may comprise a discount coupon or a special offer that is made available to only a select few users.

In addition to geo-spatial triggering, particular embodiments may be triggered with targeted communications such as email, text messaging, internet pop-up advertising, etc.

Particular embodiments use the user's smartphone, tablet, AR headset, or computer to project the model and uses application software on those devices to control the interactions with the AR models.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

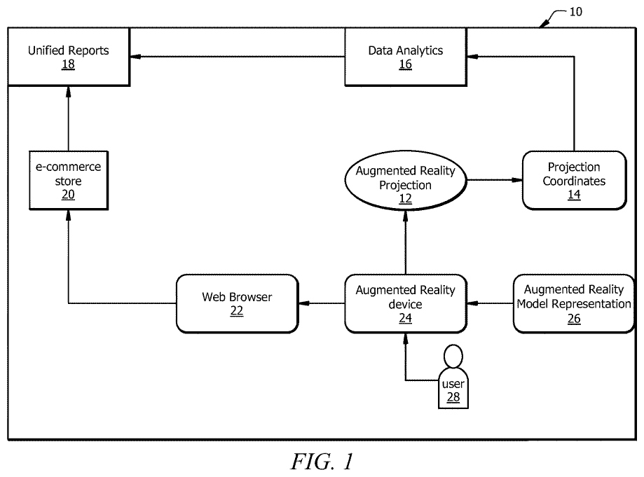

FIG. 1 illustrates a block diagram of a system for e-commerce transactions using augmented reality, in accordance with particular embodiments. System 10 includes augmented reality projection 12. Augmented reality projection 12 may comprise an augmented reality model that is projected onto a flat surface. Augmented reality projection 12 may be selected from one or more augmented reality model representations 26. Augmented reality projection 12 may represent a coupon, gift card, offer code, virtual product, or any other suitable product promotion.

System 10 may include projection coordinates 14. For example, user 28 may interact with the augmented reality model by performing pan, rotate, zoom in, zoom out, and flip operations. User 28 may manipulate the augmented reality model to reveal a coupon or gift card, as an example. These operations may be stored in a database for assessing, analyzing, and/or correlating user interaction behavior.

System 10 may include data analytics engine 16. Data analytics engine 16 comprises a data analytics platform that accepts the augmented reality projection coordinates and analyzes any patterns.

System 10 may include reports engine 18. Reports engine 18 may generate unified reports for review of customer behavior and interactions.

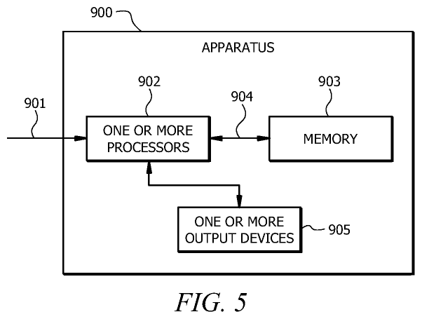

System 10 may include e-commerce store 20. E-commerce store 20 comprises any store where user 28 may purchase objects that were projected and/or redeem a coupon or gift card that was projected. E-commerce store 20 may comprise any suitable combination of hardware and software for providing e-commerce transactions. The combination of hardware and software may also be referred to as an e-commerce engine. The e-commerce engine may be implemented according to one or more of the apparatus described with respect to FIG. 5.

In some embodiments, system 10 also includes web browser 22. Web browser 22 may comprise a web browser used to search for an object and input purchase details.

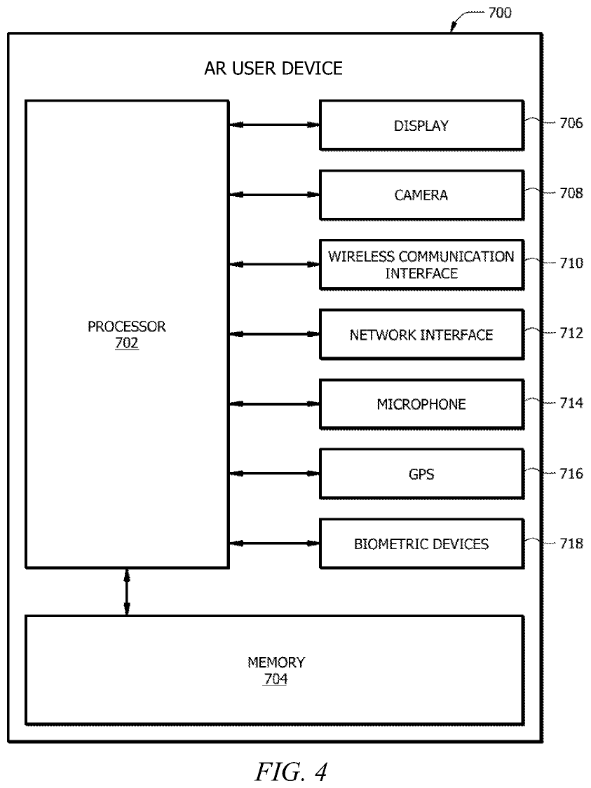

System 10 also includes augmented reality device 24. Augmented reality device 24 may comprise a smart phone, smart glasses, head mounted visor, or computer tablet that is capable of downloading, processing, and projecting an augmented reality model, such as augmented reality model 26. Augmented reality device 24 is described in more detail with respect to FIG. 4.

In particular embodiments, AR device 24 determines a surface in the field of view of a user for projection of the AR model. In some embodiments, AR device 24 may analyze the field of view and identify a suitable surface for projection of the AR model. For example, AR device 24 may determine to display a gift box on a coffee table, display a poster on blank space on a wall, etc.

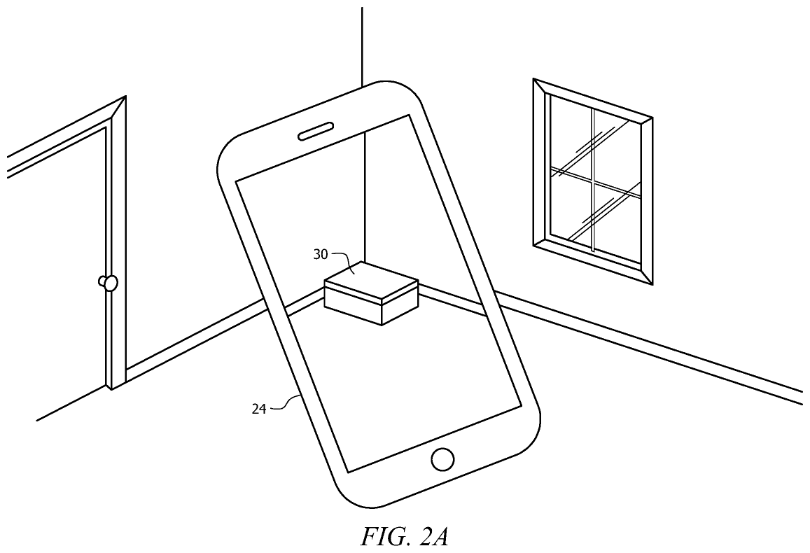

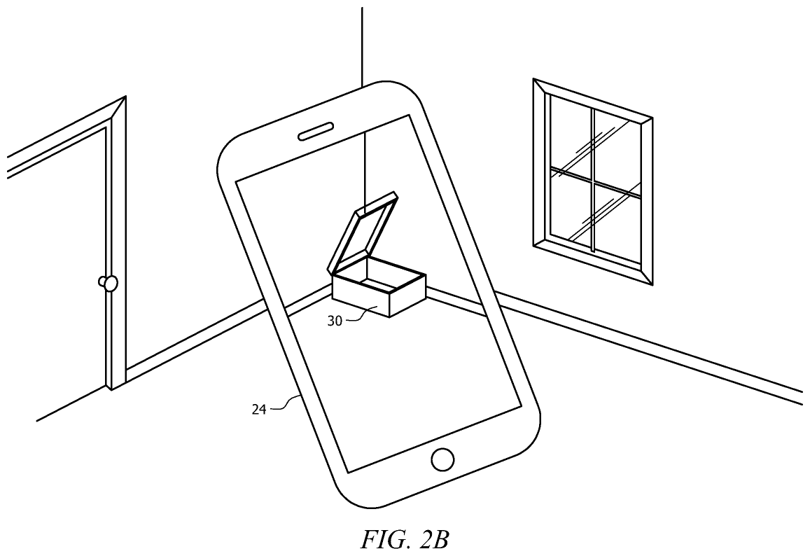

Some examples of system 10 in operation are described with respect to FIGS. 2A and 2B.

FIGS. 2A and 2B illustrate a augmented reality view of an augmented reality model, according to particular embodiments. In the illustrated example, the augmented reality model may refer to a gift card. For example, some may perceive of giving a gift card as impersonal compared to other gift options. Particular embodiments may add a personal aspect to gift card giving.

For example, a first user (e.g., gift giver) may visit the web site of an e-commerce provider. The user may select a gift card for a second user (e.g., user 28 illustrated in FIG. 1). In addition to selecting an amount for the gift card, the first user may also select an avatar or personalized video to accompany an augmented reality model (e.g., augmented reality model 26) representing the gift card. After purchasing the gift card, the second user may receive a notification of the gift via email, text, voice, or any other suitable communication. The notification may include a link to an augmented reality model representing the gift card.

The second user may access the augmented reality model representing the gift card via an augmented reality device (e.g., augmented reality device 24 illustrated in FIG. 1). For example, the accessing the augmented reality model via the augmented reality device may result in augmented reality projection 30 being projected into the field of view of the second user. In the illustrated example, augmented reality projection 30 may comprise a gift box (e.g., FIG. 2A).

The second user may interact with augmented reality projection 30 to virtually open the gift box. Upon opening the gift box (e.g. FIG. 2B), the second user may experience a personalized audio and/or video (e.g., an avatar, audio/video recording, holographic projection, etc.) message projected into the field of view of the second user.

The second user may further interact with augmented reality projection 30 to store the gift card in a digital wallet, or to redeem the gift card at the e-commerce provider.

Although the example illustrated in FIGS. 2A and 2B illustrate a particular example of a gift card, a system for e-commerce transactions using augmented reality may comprise other suitable applications. For example, another example may include virtual grocery shopping.

A first user may walk through a store, such as a grocery store, placing virtual items in a virtual shopping cart. The first user may send a representation of the virtual shopping cart to itself or to someone else (e.g., as a gift basket). The recipient may receive a notification and may be able to view the contents of the virtual shopping cart via an augmented reality device. The recipient may interact with an augmented reality projection of the virtual shopping cart to receive the items as a gift basket or to have the items delivered via a delivery service.

Another example may include a restaurant that provides an AR model representing one or more menu items. The AR model may also include attributes associated with each menu item, such as recipe, ingredients, source of ingredients, nutritional information, etc.

Some embodiments may include works of art and the AR model may include a unique identifier to associate the AR model with the real world work of art.

In particular embodiments, the AR model may include a serial number, a seal of authenticity, and/or a trademark to associate the AR model with a real world object. The AR model may include a non-fungible token (NFT). The AR models may be traded in a digital marketplace.

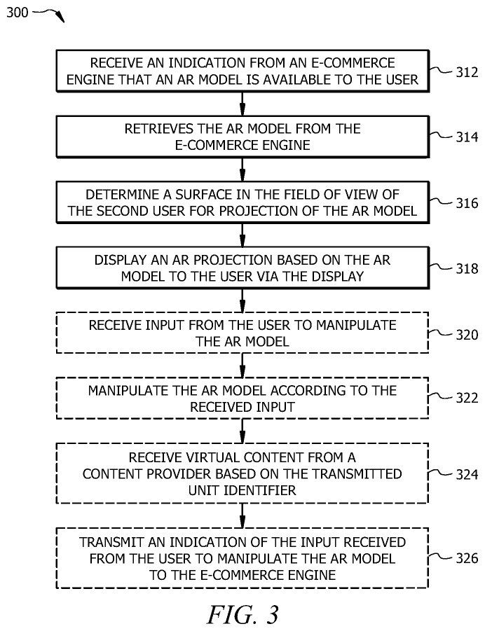

FIG. 3 illustrates a flowchart of a method performed by an AR device, in accordance with particular embodiments. In particular embodiments, one or more steps of FIG. 3 may be performed by an AR device described with respect to FIG. 4. The AR device comprises a display configured to overlay virtual objects onto a field of view of a user in real-time.

The method begins at step 312, where the AR device receives an indication from an e-commerce engine that an AR model is available to the user. The AR model represents an e-commerce product and comprises attributes describing the e-commerce product. For example, a first user may purchase a gift card for a second user (e.g., user 38) via an e-commerce engine (e.g., e-commerce store 20). AR device 24 may receive an indication from the e-commerce engine that an AR model (e.g., virtual representation of the gift card) is available. The AR model may include a graphical representation of the gift card and a dollar amount associated with the gift card.

The indication may include an email, text message, application notification, voice message, hyper-link, or any other suitable notification.

At step 314, the AR device retrieves the AR model from the e-commerce engine. The AR model represents a product offered by the e-commerce engine (e.g., gift card). For example, AR device 24 may retrieve AR model representation 26 from the e-commerce engine.

At step 316, the AR device displays an AR projection based on the AR model to the user via the display. The AR projection represents the product represented by the AR model. For example, as illustrated in FIGS. 2A and 2B, AR device 24 may display augmented reality projection 30 comprising a gift box to user 28.

At step 318, the AR device may receive input from the user to manipulate the AR model. For example, augmented reality projection 30 may comprise a gift box and user 28 may provide input via AR device 24 to pick up, rotate, and/or open the gift box.

At step 320, the AR device may manipulate the AR model according to the received input. Particular manipulations, such as opening a gift box, may trigger other actions such as a displaying or playing back a personalized message and/or revealing contents of the gift box.

At step 322, the AR device may store the representation of the gift card, coupon code, or offer code in a digital wallet. For example, after user 24 opens the gift box to reveal the gift card, the user may instruct the AR device to transfer the gift card to a digital wallet for later use with the e-commerce store.

At step 324, the AR device may transmit an indication of the input received from the user to manipulate the AR model to the e-commerce engine. The e-commerce engine may store the indication. Over time, the e-commerce engine may store multiple indications from the same user. The e-commerce engine may analyze the stored indications for patterns of behavior for the user. The patterns may inform marketing decisions.

Modifications, additions, or omissions may be made to method 300 of FIG. 3. Additionally, one or more steps in the method of FIG. 3 may be performed in parallel or in any suitable order.

FIG. 4 is a block diagram illustrating an example augmented reality (AR) device. AR device 700 may be configured to overlay virtual content, according to any of the examples and embodiments described above. Examples of AR device 700 in operation are described with respect to FIGS. 1-3.

AR device 700 comprises a one or more processors 702, a memory 704, and a display 706. Particular embodiments may include a camera 708, a wireless communication interface 710, a network interface 712, a microphone 714, a global position system (GPS) sensor 716, and/or one or more biometric devices 718. AR device 700 may be configured as shown or in any other suitable configuration. For example, AR device 700 may comprise one or more additional components and/or one or more shown components may be omitted.

Processor 702 comprises one or more CPU chips, logic units, cores (e.g., a multi-core processor), FPGAs, ASICs, or DSPs. Processor 702 is communicatively coupled to and in signal communication with memory 704, display 706, camera 708, wireless communication interface 710, network interface 712, microphone 714, GPS sensor 716, and biometric devices 718. Processor 302 is configured to receive and transmit electrical signals among one or more of memory 704, display 706, camera 708, wireless communication interface 710, network interface 712, microphone 714, GPS sensor 716, and biometric devices 718. The electrical signals are used to send and receive data (e.g., images captured from camera 708, virtual objects to display on display 706, etc.) and/or to control or communicate with other devices. For example, processor 702 transmits electrical signals to operate camera 708. Processor 702 may be operably coupled to one or more other devices (not shown).

Processor 702 is configured to process data and may be implemented in hardware or software. Processor 702 is configured to implement various instructions and logic rules, such as instructions and logic rules 220. For example, processor 702 is configured to display virtual objects on display 706, detect hand gestures, identify virtual objects selected by a detected hand gesture (e.g., identify virtual content display opportunities), and capture biometric information of a user via one or more of camera 708, microphone 714, and/or biometric devices 718. In an embodiment, the functions of processor 702 may be implemented using logic units, FPGAs, ASICs, DSPs, or any other suitable hardware.

Memory 704 comprises one or more disks, tape drives, or solid-state drives, and may be used as an over-flow data storage device, to store programs when such programs are selected for execution, and to store instructions and data that are read during program execution, such as instructions and logic rules 220. Memory 704 may be volatile or non-volatile and may comprise ROM, RAM, TCAM, DRAM, and SRAM. Memory 704 is operable to store, for example, instructions for performing the functions of AR device 700 described herein, and any other data or instructions.

Display 706 is configured to present visual information to a user in an augmented reality environment that overlays virtual or graphical objects onto tangible objects in a real scene in real-time. In an embodiment, display 706 is a wearable optical display configured to reflect projected images and enables a user to see through the display. For example, display 706 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matrix OLED (AMOLED), an organic LED (OLED) display, a projector display, or any other suitable type of display as would be appreciated by one of ordinary skill in the art upon viewing this disclosure. In another embodiment, display 706 is a graphical display on a user device. For example, the graphical display may be the display of a tablet or smart phone configured to display an augmented reality environment with virtual or graphical objects overlaid onto tangible objects in a real scene in real-time.

Examples of camera 708 include, but are not limited to, charge-coupled device (CCD) cameras and complementary metal-oxide semiconductor (CMOS) cameras. Camera 708 is configured to capture images of a wearer of AR device 700, such as user 102. Camera 708 may be configured to capture images continuously, at predetermined intervals, or on-demand. For example, camera 708 may be configured to receive a command from user 102 to capture an image. In another example, camera 708 is configured to continuously capture images to form a video stream. Camera 708 is communicably coupled to processor 702.

Examples of wireless communication interface 710 include, but are not limited to, a Bluetooth interface, an RFID interface, an NFC interface, a local area network (LAN) interface, a personal area network (PAN) interface, a wide area network (WAN) interface, a Wi-Fi interface, a ZigBee interface, or any other suitable wireless communication interface as would be appreciated by one of ordinary skill in the art upon viewing this disclosure. Wireless communication interface 710 is configured to facilitate processor 702 to communicating with other devices. For example, wireless communication interface 710 is configured to enable processor 702 to send and receive signals with other devices. Wireless communication interface 710 is configured to employ any suitable communication protocol.

Network interface 712 is configured to enable wired and/or wireless communications and to communicate data through a network, system, and/or domain. For example, network interface 712 is configured for communication with a modem, a switch, a router, a bridge, a server, or a client. Processor 702 is configured to receive data using network interface 712 from a network or a remote source, such as cloud storage device 110, institution 122, mobile device 112, etc.

Microphone 714 is configured to capture audio signals (e.g. voice signals or commands) from a user, such as user 102. Microphone 714 is configured to capture audio signals continuously, at predetermined intervals, or on-demand. Microphone 714 is communicably coupled to processor 702.

GPS sensor 716 is configured to capture and to provide geographical location information. For example, GPS sensor 716 is configured to provide a geographic location of a user, such as user 28, employing AR device 700. GPS sensor 716 may be configured to provide the geographic location information as a relative geographic location or an absolute geographic location. GPS sensor 716 may provide the geographic location information using geographic coordinates (i.e., longitude and latitude) or any other suitable coordinate system. GPS sensor 716 is communicably coupled to processor 702.

Examples of biometric devices 718 include, but are not limited to, retina scanners and fingerprint scanners. Biometric devices 718 are configured to capture information about a person's physical characteristics and to output a biometric signal based on captured information. A biometric signal is a signal that is uniquely linked to a person based on their physical characteristics. For example, biometric device 718 may be configured to perform a retinal scan of the user's eye and to generate a biometric signal for the user based on the retinal scan. As another example, a biometric device 718 is configured to perform a fingerprint scan of the user's finger and to generate a biometric signal for the user based on the fingerprint scan. Biometric device 718 is communicably coupled to processor 702.

FIG. 5 illustrates an example of an apparatus to implement one or more example embodiments described herein. In this example, the apparatus 900 may include one or more processors 902, one or more output devices 905, and a memory 903. The apparatus 900 may be a computer.

In one embodiment, the one or more processors 902 may include a general purpose processor, an integrated circuit, a server, other programmable logic device, or any combination thereof. The processor may be a conventional processor, microprocessor, controller, microcontroller, or state machine. The one or more processors may be one, two, or more processors of the same or different types. Furthermore, the one or more processors may be a computer, computing device and user device, and the like.

In one example, based on user input 901 and/or other input from a computer network, the one or more processors 902 may execute instructions stored in memory 903 to perform one or more example embodiments described herein. Output produced by the one or more processors 902 executing the instructions may be output on the one or more output devices 905 and/or output to the computer network.

The memory 903 may be accessible by the one or more processors 902 via the link 904 so that the one or more processors 902 can read information from and write information to the memory 903. Memory 903 may be integral with or separate from the processors. Examples of the memory 903 include RAM, flash, ROM, EPROM, EEPROM, registers, disk storage, or any other form of storage medium. The memory 903 may store instructions that, when executed by the one or more processors 902, implement one or more embodiments of the invention. Memory 903 may be a non-transitory computer-readable medium that stores instructions, which when executed by a computer, cause the computer to perform one or more of the example methods discussed herein.

Numerous modifications, alterations, and changes to the described embodiments are possible without departing from the scope of the present invention defined in the claims. It is intended that the present invention is not limited to the described embodiments, but that it has the full scope defined by the language of the following claims, and equivalents thereof.

What is claimed is:

1. A system for performing an electronic transaction in an augmented reality (AR) environment, the system comprising an e-commerce engine and an AR device;
the e-commerce engine comprising one or more processors operable to:
receive a request to transmit an AR model to a user, wherein the AR model represents an e-commerce product and comprises attributes describing the e-commerce product;
determine an AR device associated with the user;
transmit an indication to the AR device that the AR model is available to the user;
the AR device comprising a display configured to overlay virtual objects onto a field of view of the user in real-time and one or more processors coupled to the display, the one or more processors operable to:
receive the indication that the AR model is available to the user;
retrieve the AR model from the e-commerce engine;
determine a surface in the field of view of the second user for projection of the AR model; and
display on the determined surface an AR projection based on the AR model to the user via the display.

2. The system of claim 1, the AR device one or more processors further operable to:
receive input from the user to manipulate the AR model; and
manipulate the AR model according to the received input.

3. The system of claim 1, wherein the AR model comprises a representation of a gift card.

4. The system of claim 3, wherein the AR device one or more processors are further operable to store the representation of the gift card in a digital wallet.

5. The system of claim 2, wherein the AR model comprises a container and the AR device one or more processors manipulate the AR model by opening the container.

6. The system of claim 2, the e-commerce engine one or more processors further operable to:
receive an indication of the input received from the user to manipulate the AR model; and
store the indication of the input received from the user to manipulate the AR model.

7. The system of claim 6, the e-commerce engine one or more processors further operable to analyze patterns within the stored indication of the input received from the user to manipulate the AR model.

8. The system of claim 1, the e-commerce engine one or more processors further operable to generate a report pertaining to the AR model retrieved by the AR device.

9. A method performed by an augmented reality (AR) device, the AR device comprising a display configured to overlay virtual objects onto a field of view of a user in real-time, the method comprising:
receiving an indication from an e-commerce engine that an AR model is available to the user, wherein the AR model represents an e-commerce product and comprises attributes describing the e-commerce product;
retrieving the AR model from the e-commerce engine, the AR model representing a product offered by the e-commerce engine;
determining a surface in the field of view of the second user for projection of the AR model; and
displaying on the determined surface an AR projection based on the AR model to the user via the display, the AR projection representing the product represented by the AR model.

10. The method of claim 9, further comprising:
receiving input from the user to manipulate the AR model; and
manipulating the AR model according to the received input.

11. The method of claim 9, wherein the AR model comprises a representation of a gift card, coupon code, or offer code.

12. The method of claim 11, further comprising storing the representation of the gift card, coupon code, or offer code in a digital wallet.

13. The system of claim 10, wherein the AR model comprises a container and wherein manipulating the AR model comprises opening the container.

14. The method of claim 10, further comprising transmitting an indication of the input received from the user to manipulate the AR model to the e-commerce engine.

15. An augmented reality (AR) device, the AR device comprising a display configured to overlay virtual objects onto a field of view of a user in real-time and one or more processors coupled to the display, the one or more processors operable to:
receive an indication from an e-commerce engine that an AR model is available to the user, wherein the AR model represents an e-commerce product and comprises attributes describing the e-commerce product;
retrieve the AR model from the e-commerce engine, the AR model representing a product offered by the e-commerce engine;
determine a surface in the field of view of the second user for projection of the AR model; and
display on the determined surface an AR projection based on the AR model to the user via the display, the AR projection representing the product represented by the AR model.

16. The AR device of claim 15, the one or processors further operable to:
receive input from the user to manipulate the AR model; and
manipulate the AR model according to the received input.

17. The AR device of claim 15, wherein the AR model comprises a representation of a gift card, coupon code, or offer code.

18. The AR device of claim 17, the one or more processors further operable to store the representation of the gift card, coupon code, or offer code in a digital wallet.

19. The AR device of claim 16, wherein the AR model comprises a container and wherein the one or more processors are operable to manipulate the AR model by opening the container.

20. The AR device of claim 16, the one or more processors further operable to transmit an indication of the input received from the user to manipulate the AR model to the e-commerce engine.
